(19) United States
(12) Patent Application Publication
(10) Pub. No.: US 2007/0113603 A1
(43) Pub. Date: May 24, 2007

(54) Lock with a locking cylinder

(75) Inventor: Mario Polster, Suhl (DE)

Correspondence Address: YOUNG & THOMPSON, 745 SOUTH 23RD STREET, 2ND FLOOR, ARLINGTON, VA, 22202, US

(73) Assignee: AUG. WINKHAUS GMBH & CO. KG., TELGTE (DE)

(21) Appl. No.: 11/511,468

(22) Filed: Aug. 29, 2006

(30) Foreign Application Priority Data
Nov. 24, 2005 (DE) 10 2005 000 165.3

(51) Int. Cl. E05B 59/00; E05B 63/14

(52) U.S. Cl. 70/107

(57) ABSTRACT

In a lock with a locking cylinder (3), the locking cylinder (3) has a knob (30) on one side and on the other side has a lock channel for insertion of a key (31). The lock has two split hubs (4, 5) on top of one another for triggering a locking element (6). Furthermore, the lock has a positioning element (24) which establishes whether blocking of the locking element (6) produced by the locking cylinder (3) can be canceled by actuation of the split hubs (4, 5). A projection (21) which is located on a plate (20) which interacts with the positioning element (24) establishes from which side this blocking can be cancelled.

The invention relates to a lock with a locking cylinder, with a latch, with a locking means which can be moved into a locking position and an unlocking position, with two opposing split hubs for triggering the latch and the locking means, with a locking cylinder pull which can move lengthwise and which is guided to a receiver for the locking cylinder, depending on the position of the locking cylinder pull the locking means being blocked or released, with energy transmission means located between the split hubs and the locking means.

This lock is known for example from EP 0 913 550 B1 and has two actuating planes in which there is one of the split hubs at a time. The locking means is made as a driving rod and can be selectively driven by one split hub or the other split hub. To establish the main operating side of the lock one of the split hubs can be connected to the latch driver-cam disk which is supported between the split hub. The disadvantage in this lock is however that it cannot be recognized from the outside whether the lock is in the locking position or in the unlocking position.

The object of the invention is to develop a lock of the initially mentioned type such that it displays on one side a simple indication of the blocking or release of the locking means.

This object is achieved as claimed in the invention in that the locking cylinder on the main operating side has a knob and on the secondary operating side has a lock channel for insertion of a key, that the knob is permanently coupled to the beard of the locking cylinder and has a mark for indication of the locking position and the unlocking position, that the locking cylinder pull is coupled in both directions of motion to the locking cylinder and that at least one of the split hubs is coupled to means for moving the locking cylinder pull for moving the knob of the locking cylinder when the locking means is moved into the unlocking position.

The locking cylinder pull is driven by this configuration when the locking means is driven via the respective split hub into the unlocked position. In doing so the knob is likewise moved at the same time and indicates by its position the blocking or release of the locking means. In the door-mounted state of the lock as claimed in the invention, the knob is located on the inside of the door, the so-called main operating side. On the outside of the door, the so-called secondary operating side, only the locking channel is visible. Since the side of the locking cylinder which has the locking channel is coupled only to the beard when a key is inserted into the locking channel, the blocking or release of the locking means cannot be recognized from the secondary operating side. Preferably the mark is made as a nonround shape, for example by an oblong configuration of the knob.

The construction effort for selective blocking or release of the motion of the locking means depending on the position of the locking cylinder pull can be kept especially small according to one advantageous development of the invention when a ratchet lever which engages the locking means is connected via a rocker to the locking cylinder pull.

Catching of the ratchet lever between its end position can be easily achieved according to another advantageous development of the invention when one end of the rocker is pretensioned via a spring element with the locking cylinder pull in one direction and with its side of this end of the rocker facing away from the spring element is opposite a control pin located on the locking cylinder pull.

Often it is desirable for the blocking of the locking means to be releasable selectively via the locking cylinder or additionally from the main operating side via the respective split hub. From the secondary operating side the blocking of the locking means will be cancelled solely via the locking cylinder. The locking cylinder pull can be driven according to another advantageous development of the invention by means of one of the split hubs when a projection is connected to the locking cylinder pull and when the projection protrudes into the region of movement of a shoulder of one of the split hubs when the split hub is being driven into the position which unlocks the locking means. Thus the projection is made as a part of the means for moving the locking cylinder pull. By this configuration the blocking of the locking means can be cancelled by the driving of the respective split hub and then the locking position can move into the unlocking position via the respective split hub. The split hub which interacts with the projection establishes the main operation side of the lock.

The main operating side and the secondary operating side of the lock as claimed in the invention can be easily selected when the two split hubs each have a shoulder and when the projection can be moved selectively into the region of movement of the shoulder of one split hub or into the region of movement of the shoulder of the other split hub. By moving the projection the interaction of the respective split hub with the locking cylinder pull and thus the main operating side of the lock is established. Thus the lock which has been locked via the locking cylinder can be unlocked via the split hub which is located on the main operating side. In addition, in the choice of the main operating side the knob of the locking cylinder can be located on the side of the split hub which interacts with the projection.

The movement of the projection is made especially simple according to another advantageous development of the invention when the projection is part of a stud bolt.

For various applications of locks it is desirable for the blocking of the locking means to take place solely via the locking cylinder. It could be considered that to do this the projection opposite the shoulder of the split hub simply be dismounted by removing for example the stud bolt which has the projection. The lock as claimed in the invention can however be adapted especially easily to different applications when the projection is located on the plate which is pivotally mounted on the locking cylinder pull, when the plate is pretensioned against a positioning means and when the positioning means can be moved into two positions, the positioning means in one position deflecting the plate such that the projection protrudes into the region of motion of the shoulder, and in the other position the projection being located outside of the region of motion of the shoulder. Thus, it is established via the position of the positioning means whether blocking of the locking means can be canceled from the main operating side solely by means of the locking cylinder or additionally by means of the split hub.

The movement of the positioning means is made especially easy according to another advantageous development of the invention when the positioning means is made as a slide.

The coupling of the locking cylinder in two directions of motion with the locking cylinder pull is made especially simple in terms of construction according to another advantageous development of the invention when the receiver of the locking cylinder has a sprocket.

According to one advantageous development of the invention the intended path of motion of the locking cylinder pull when the receiver of the locking cylinder is partially turned can be easily produced when there is gearing between the receiver of the locking cylinder and the locking cylinder pull.

To further reduce the structural complexity of the lock as claimed in the invention, it is helpful if the slide of the locking means is coupled to a bolt and/or a driving rod, and has a driver for moving the locking cylinder pull. The driver is used in addition to the projection on the locking cylinder pull and the shoulder which interacts with the projection on the split hub for complete motion of the locking cylinder pull and thus of the knob of the locking cylinder into the position which indicates the release of the locking means.

In the mounted state of the lock as claimed in the invention, movement of the locking means into the locking position can be easily avoided when the feeler of a misoperation safeguard is pretensioned out of the lock case and in its position projecting out of the lock case positively engages the slide of the locking means. In this way the misoperation safeguard prevents bolts and the like from being unintentionally drawn out when a wing of the door which has the lock as claimed in the invention is not in the frame.

The invention allows numerous embodiments. To further illustrate its basic principle one is shown in the drawings and is described below.

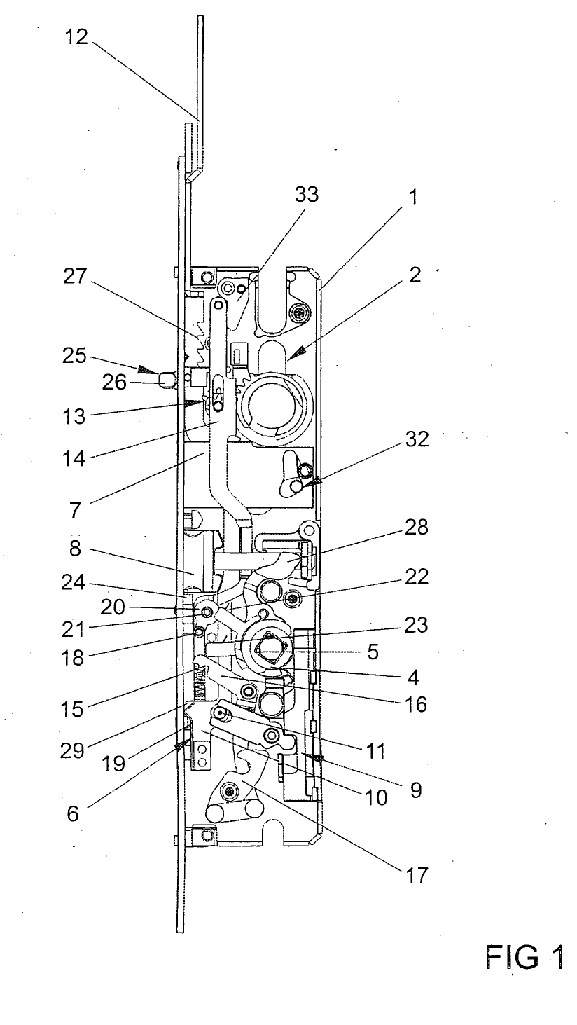

FIG. 1 shows the lock as claimed in the invention in the unlocked position,

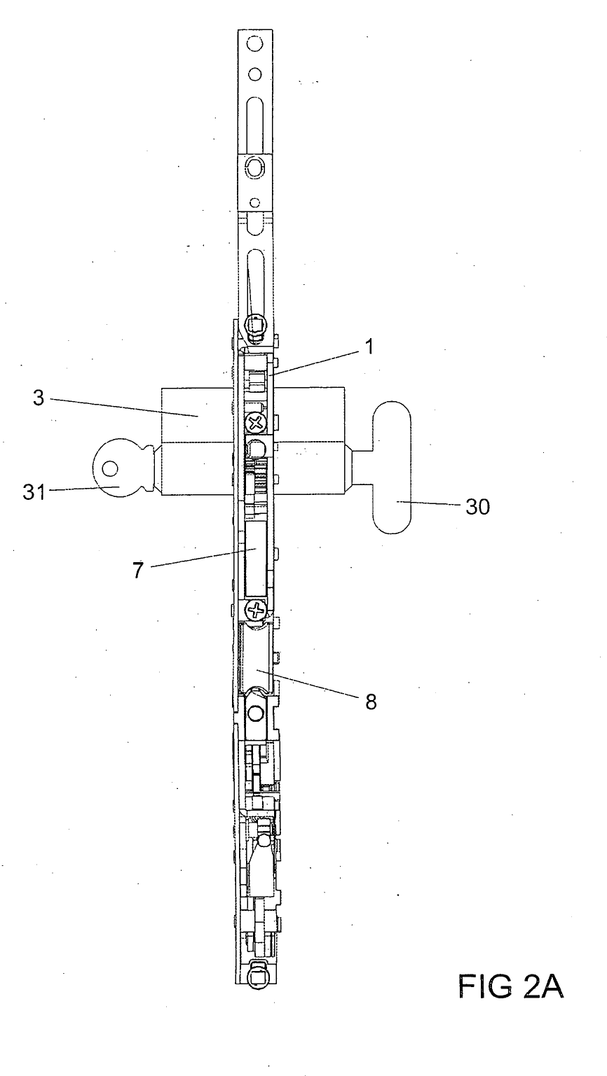

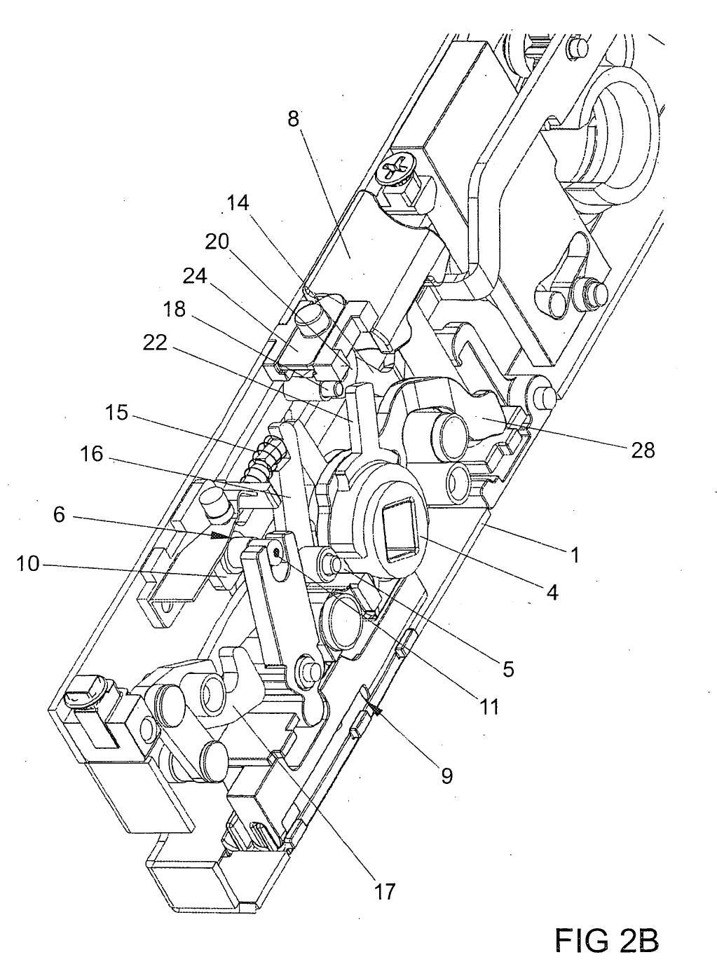

FIG. 2a shows the lock as claimed in the invention from FIG. 1 in a side view,

FIG. 2b shows highly enlarged a partial region of the lock as claimed in the invention from FIG. 1 in a perspective,

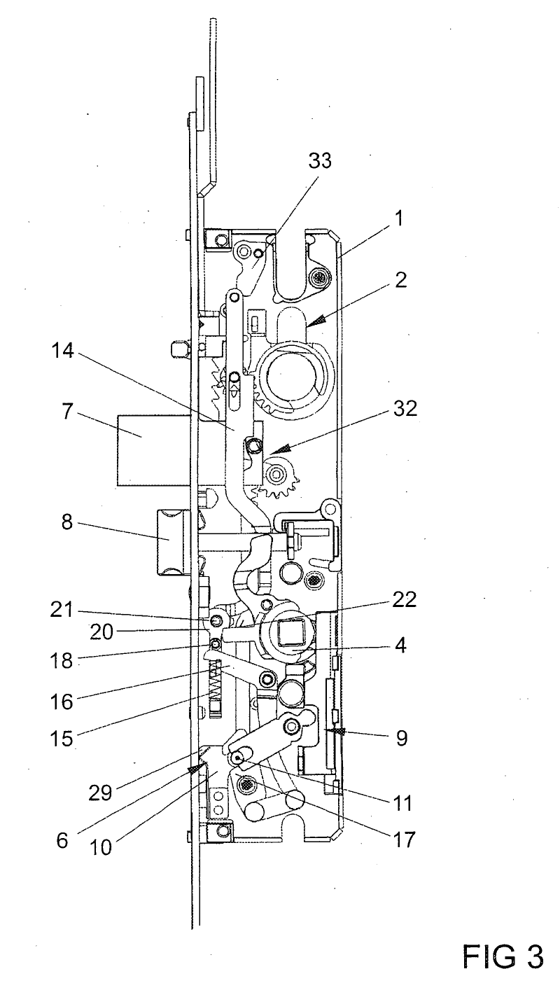

FIG. 3 shows the lock as claimed in the invention from FIG. 1 in the locked position in the operating position in which the lock can be unlocked solely by way of the locking cylinder,

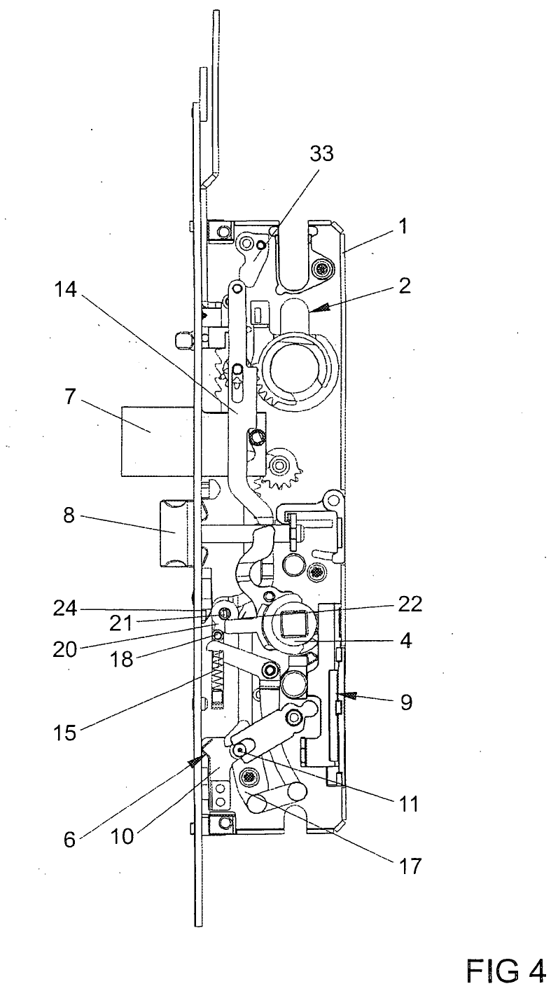

FIG. 4 shows the lock as claimed in the invention from FIG. 1 in the locked position in another operating position in which the lock can be unlocked via the split hub.

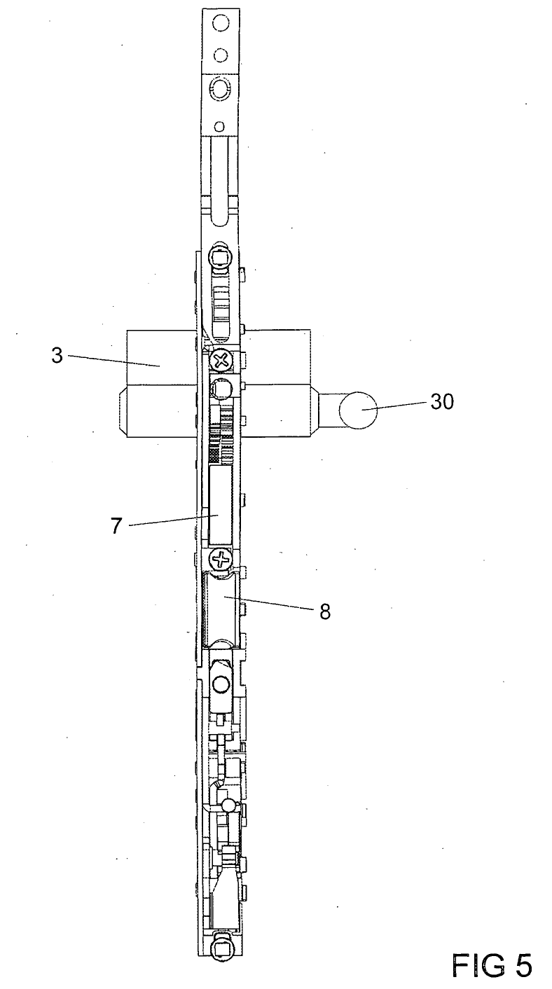

FIG. 5 shows the lock as claimed in the invention from FIG. 4 in a view from the side.

FIG. 1 shows a lock in the unlocked position with a lock case 1 and with a receiver 2 for the locking cylinder 3 shown in FIG. 2a. Furthermore the lock has two split hubs 4, 5 located on top of one another for triggering a locking means 6. The two split hubs 4,5 and the components corresponding to them are shown highly enlarged in FIG. 2b for clarity. The lock case 1 is shown open to illustrate the lock components. The lock has a bolt 7 and a latch 8 which can be pretensioned out of the lock case by way of a spring element which is not shown. The locking means 6 has energy transmission means 9 connected to the split hubs 4, 5. The energy transmission means 9 act on the pin 11 mounted in the slide 10. The slide 10 engages a driving rod 12 and the bolt 7.

The receiver 2 for the locking cylinder 3 is connected by way of gearing 13 to the locking cylinder pull 14. The locking cylinder pull 14 is connected via a spring element 15 and to a rocker 16 and via the rocker 16 to the pivotally mounted ratchet lever 17. Furthermore the locking cylinder pull 14 has a control pin 18 which is opposite one end of the rocker 16. A driver 29 located on the slide 10 strikes the free end of the locking cylinder pull 14. A pivotally mounted spring element 33 is used as a catch of the end positions of the locking cylinder pull 14. A plate 20 with a projection 21 is mounted on the locking cylinder pull 14 to be able to pivot around the control pin 18. The plate 20 is located in the plane between the shoulders 22, 23 of the split hubs 4, 5. The projection 21 is made as a stud bolt which is screwed into the plate 20. Thus the projection 21 can be placed selectively opposite the shoulder 22 of one split hub 4 or the shoulder 23 of the other split hub. The plate 20 is pretensioned against a positioning means 24.

A misoperation safeguard 25 has a feeler 26 which is pretensioned out of the lock case 1 and which engages teeth 27 of the slide 10. In the door-mounted state of the lock the misoperation safeguard 25 blocks motion of the slide 10 and thus the locking means 6 when the door is not closed.

In the unlocked position shown in FIGS. 1, 2a and 2b the front of the split hub 4 is shown swivelled clockwise and via the latch return lever 28 presses the latch 8 back into the lock case 1. Furthermore the energy transmission means 9 of the locking means 6 are pushed by way of the illustrated position of the split hub 4 which is the front one in the plane of the drawings such that the slide 10 is pushed via the pin 11 up in the plane of the drawings. Here the bolt 7 is likewise pressed back into the position retracted in the lock case 1. The driver 29 of the slide 10 moreover presses the locking cylinder pull 14 up in the plane of the drawings so that the receiver 2 for the locking cylinder 3 is likewise turned. In doing so a knob 30 of the locking cylinder 3 is moved into the unlocked position. The lock can thus be recognized as unlocked from the outside by looking at the knob 30 of the locking cylinder 3. The knob 30 is mounted on the so-called main operating side of the lock, while on the opposite, secondary operating side the locking cylinder 3 can be actuated only by way of an inserted key 31.

If proceeding from the position shown in FIG. 1 the split hub 4 shown deflected is released, the latch 8 is forced out of the lock case 1 by the force of the spring element and in doing so the split hub 4 is swivelled back by means of the elastically mounted energy transmission means 9. Then, by selectively turning one of the split hubs 4, 5 counterclockwise the locking means 6 can be driven and the lock moved into the locked position. By selectively turning one of the split hubs 4, 5 the energy transmission means 9 of the locking means 6 are driven and the pin 11 mounted on the slide 10 is pushed. The main driving gear 32 located between the slide 10 and the bolt 7 moves the bolt 7 out of the lock case 1 and can be pulled back again into the lock case 1 by subsequent driving of the split hubs 4, 5 together with the latch 8. But if the locking cylinder 3 is actuated in the position in which the bolt 7 projects out of the lock case 1, the locking cylinder pull 14 moves down, viewed in the plane of the drawing, as shown in FIG. 3. By moving the locking cylinder pull 14 the rocker 16 is deflected by the control pin 18 and the ratchet lever 17 engages the region of motion of the pin 11 attached to the slide 10. Thus the locking means 6 is blocked and the lock locked and cannot be unlocked by driving the split hubs 4, 5. Since the knob 30 shown in FIG. 2 has been turned when the locking cylinder 3 moves into the locked position, it can be recognized using the position of the knob 30 from outside the lock that the lock is locked.

If the lock is to be unlocked proceeding from the position shown in FIG. 3, first the locking cylinder 3 must be actuated either via the key 31 or via the knob 30. In this position the lock can only be unlocked via actuation of the locking cylinder 3. With this actuation the locking cylinder pull 3 is moved up in the plane of the drawing and thus the control pin 18 is moved away from the end of the rocker 16. At the same time, the spring element 15 which connects the rocker 16 to the locking cylinder pull 14 is relieved and in doing so the rocker 16 is deflected. This leads to movement of the ratchet lever 17 out of the region of motion of the pin 11 located on the slide 10 and thus to cancellation of blocking of the locking means 6.

FIG. 4 shows the lock from FIG. 1 in the locked position. In contrast to the position shown in FIG. 3, the plate 20 in FIG. 4 is deflected via the positioning means 24 so that the projection 21 moves into the region of motion of one of the shoulders 22, 23 of the split hubs 4,5. If the split hub 4 which interacts with the projection 21 is turned slightly clockwise, the shoulder 22 presses the projection 21 and thus the locking cylinder pull 14 up, viewed in the plane of the drawing. In this way the blocking lever 17 is moved out of the region of motion of the pin 11 mounted on the slide 10 and the lock can be unlocked via the split hub 4 in the position shown in FIG. 1. The positioning means 24 is made as a slide and enables, depending on the two operating positions shown in FIGS. 3 and 4, whether the lock, as shown in FIG. 3, can be unlocked solely by way of the locking cylinder 3 or as shown in FIG. 4 additionally by way of the split hub 4, 5 which interacts with the projection 21 [sic]. The location of the projection 21 on the plate 20 establishes via which of the two split hubs 4, 5 the lock can be unlocked in the operating position of the positioning means 24 shown in FIG. 4. This identifies the main operating side of the lock on which the knob 30 of the locking cylinder 3 is located. The other side of the lock is often called the secondary operating side. From this side the lock can be unlocked solely via the actuation of the locking cylinder 3 by means of the key 31 shown in FIG. 2. The latch 8 and the misoperation safeguard 25 can be mounted in two positions so that the lock can be refitted for doors closing to the left and right.

FIG. 5 shows the lock from FIG. 4 in the locked position from the side. Compared to the unlocked position shown in FIG. 2, it can be clearly recognized that the knob 30 is made elongated and identifies the unlocked or locked position of the lock.

1. Lock with a locking cylinder, with a latch, with a locking means which can be moved into a locking position and an unlocking position, with two opposing split hubs for triggering the latch and the locking means, with a locking cylinder pull which can move lengthwise and which is guided to a receiver for the locking cylinder, depending on the position of the locking cylinder pull the locking means being blocked or released, with energy transmission means located between the split hubs and the locking means, characterized in that the locking cylinder (3) on the main operating side has a knob (30) and on the secondary operating side has a lock channel for insertion of a key (31), that the knob (30) is permanently coupled to the beard of the locking cylinder (3) and has a mark for indication of the locking position and the unlocking position, that the locking cylinder pull (14) is coupled in both directions of motion to the locking cylinder (3) and that at least one of the split hubs (4, 5) is coupled to means for moving the locking cylinder pull (14) for moving the knob (30) of the locking cylinder (3) when the locking means (6) is moved into the unlocking position.

2. Lock as claimed in claim 1, wherein a ratchet lever (17) which engages the locking means (6) is connected via a rocker (16) to the locking cylinder pull (14).

3. Lock as claimed in claim 2, wherein one end of the rocker (16) is pretensioned via a spring element (15) with the locking cylinder pull (14) in one direction and with its side of this end of the rocker (16) facing away from the spring element (15) is opposite a control pin (18) located on the locking cylinder pull (14).

4. Lock as claimed in claim 1, wherein a projection (21) is connected to the locking cylinder pull (14) and wherein the projection (21) protrudes into the region of movement of one shoulder (22, 23) of one of the split hubs (4, 5) when the split hub (4, 5) is being driven into the position which unlocks the locking means (6).

5. Lock as claimed in claim 4, wherein the two split hubs (4, 5) each have a shoulder (22, 23) and wherein the projection (21) can be moved selectively into the region of movement of the shoulder (22, 23) of one split hub (4, 5) or into the region of movement of the shoulder (22, 23) of the other split hub (4, 5).

6. Lock as claimed in claim 4, wherein the projection (21) is part of a stud bolt.

7. Lock as claimed in claim 4, wherein the projection (21) is located on the plate (20) which is pivotally mounted on the locking cylinder pull (14), wherein the plate (20) is pretensioned against a positioning means (24) and wherein the positioning means (24) can be moved into two positions, the positioning means (24) in one position deflecting the plate (20) such that the projection (21) protrudes into the region of motion of the shoulder (22, 23), and in the other position the projection (21) being located outside of the region of motion of the shoulder (22, 23).

8. Lock as claimed in claim 7, wherein the positioning means (24) is made as a slide.

9. Lock as claimed in claim 1, wherein the receiver (2) of the locking cylinder (3) has a sprocket.

10. Lock as claimed in claim 1, wherein there is gearing (13) between the receiver (2) of the locking cylinder (3) and the locking cylinder pull (14).

11. Lock as claimed in claim 1, wherein the slide (10) of the locking means (6) is coupled to a bolt (7) and/or a driving rod (12), and has a driver (29) for moving the locking cylinder pull (14).

12. Lock as claimed in claim 11, wherein the feeler (26) of a misoperation safeguard (25) is pretensioned out of the lock case (1) and in its position projecting out of the lock case (1) positively engages the slide (10) of the locking means (6).

13. Lock as claimed in claim 5, wherein the projection (21) is part of a stud bolt.

14. Lock as claimed in claim 5, wherein the projection (21) is located on the plate (20) which is pivotally mounted on the locking cylinder pull (14), wherein the plate (20) is pretensioned against a positioning means (24) and wherein the positioning means (24) can be moved into two positions, the positioning means (24) in one position deflecting the plate (20) such that the projection (21) protrudes into the region of motion of the shoulder (22, 23), and in the other position the projection (21) being located outside of the region of motion of the shoulder (22, 23).

15. Lock as claimed in claim 5, wherein the projection (21) is located on the plate (20) which is pivotally mounted on the locking cylinder pull (14), wherein the plate (20) is pretensioned against a positioning means (24) and wherein the positioning means (24) can be moved into two positions, the positioning means (24) in one position deflecting the plate (20) such that the projection (21) protrudes into the region of motion of the shoulder (22, 23), and in the other position the projection (21) being located outside of the region of motion of the shoulder (22, 23).

16. Lock as claimed in claim 13, wherein the projection (21) is located on the plate (20) which is pivotally mounted on the locking cylinder pull (14), wherein the plate (20) is pretensioned against a positioning means (24) and wherein the positioning means (24) can be moved into two positions, the positioning means (24) in one position deflecting the plate (20) such that the projection (21) protrudes into the region of motion of the shoulder (22, 23), and in the other position the projection (21) being located outside of the region of motion of the shoulder (22, 23).

17. Lock as claimed in claim 9, wherein there is gearing (13) between the receiver (2) of the locking cylinder (3) and the locking cylinder pull (14).
